(19) United States
(12) Patent Application Publication
(10) Pub. No.: US 2026/0100102 A1
(43) Pub. Date: Apr. 9, 2026

(54) GAMING MACHINE AND METHOD INCLUDING A VALUE TRANSFER BONUS

(71) Applicant: LNW Gaming, Inc., Las Vegas, NV (US)

(72) Inventor: Joel R. JAFFE, Glenview, IL (US)

(21) Appl. No.: 19/304,656

(22) Filed: Aug. 20, 2025

Related U.S. Application Data
(60) Provisional application No. 63/702,682, filed on Oct. 3, 2024.

(51) Int. Cl. G07F 17/32; G07F 17/34

(52) U.S. Cl. CPC G07F 17/3267; G07F 17/3213; G07F 17/3244; G07F 17/34

(57) ABSTRACT

Disclosed are a gaming machine and method for implementing a bonus game. The bonus game includes an array of cells and a plurality of indicators, each indicator bearing a plurality of values. Overlay reels bearing catalyst symbols and blank spaces are superimposed over the array. After spinning the overlay reels, if a catalyst symbol overlays an empty cell, an indicator is selected, a value is selected from the indicator and that value is locked in the empty cell. If a catalyst symbol overlays a cell that already contains a value, an indicator is selected, a value is selected from the indicator and added to the value already in the cell. At bonus game end, a prize based on all of the transferred values is awarded.

### CROSS-REFERENCE TO RELATED APPLICATIONS

This patent application claims priority benefit of U.S. Provisional Patent Application No. 63/702,682 filed Oct. 3, 2024. The disclosure of the 63/702,682 Application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024-2025, LNW Gaming, Inc.

### FIELD OF THE INVENTION

The present invention relates to a technological improvement to gaming systems, gaming machines, and methods and, more particularly, to technological improvements in connection with a bonus feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple bonus enhancements with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

Disclosed are a gaming machine and method for implementing a bonus game. The bonus game includes an array of cells and a plurality of indicators, each indicator bearing a plurality of values. Overlay reels bearing catalyst symbols and blank spaces are superimposed over the array. After spinning the overlay reels, if a catalyst symbol overlays an empty cell, an indicator is selected, a value is selected from the indicator and that value is locked in the empty cell. If a catalyst symbol overlays a cell that already contains a value, an indicator is selected, a value is selected from the indicator and added to the value already in the cell. At bonus game end, a prize based on all of the transferred values is awarded.

In accordance with one or more embodiments, a method and a gaming machine configured to execute a method of conducting a wagering game includes the steps of displaying a symbol array comprising a plurality of cells, each cell initially empty and comprising an overlay reel bearing catalyst symbols and blank spaces; displaying a plurality of indicators, each indicator bearing a plurality of values; and initializing a spin counter. The method further includes the steps of, for a plurality of game cycles: spinning and stopping the overlay reels to display a blank space or a catalyst symbol superimposed over each cell in the symbol array, then, for each respective cell in the symbol array: determining whether the respective cell contains a catalyst symbol overlaying a symbol placed in the respective cell during a previous game cycle. In response to the respective cell containing a catalyst symbol overlaying a symbol placed in the respective cell during a previous game cycle: the method includes selecting one of the plurality of indicators associated with the respective cell; selecting a value from the plurality of values borne by the selected indicator; removing the selected indicator from the plurality of indicators and adding the selected value to a value borne by the symbol placed in the respective cell during a previous game cycle; and replacing the selected indicator in the plurality of indicators with a new indicator bearing a plurality of new values. The method finally decrements the spin counter; and, in response to a terminating condition, ends the game and awards a prize.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIGS. 3A-3C combine into a flow diagram for a data processing method that corresponds to instructions executed by a controller according to an embodiment of the present invention. FIG. 3A relates to a base-game portion of a wagering game; FIG. 3B relates to execution of a bonus game; FIG. 3C relates to post-spin activity of the bonus game of FIG. 3B.

FIG. 4 is an exemplary presentation of a base-game spin outcome in accordance with one or more embodiments.

FIG. 5 is an exemplary presentation of a bonus game spin outcome in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

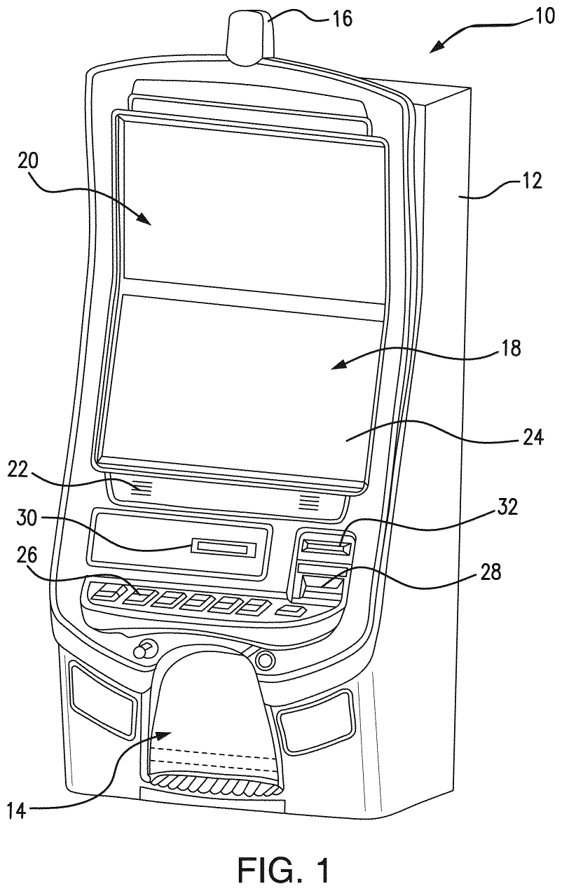

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 includes a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices, which together provide a graphical user interface, are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry 40 for processing. The electronic data signals are selected from a group consisting essentially of an electrical current, an electrical voltage, an electrical charge, an optical signal, an optical element, a magnetic signal, and a magnetic element.

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter. The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on a “credits” meter, the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

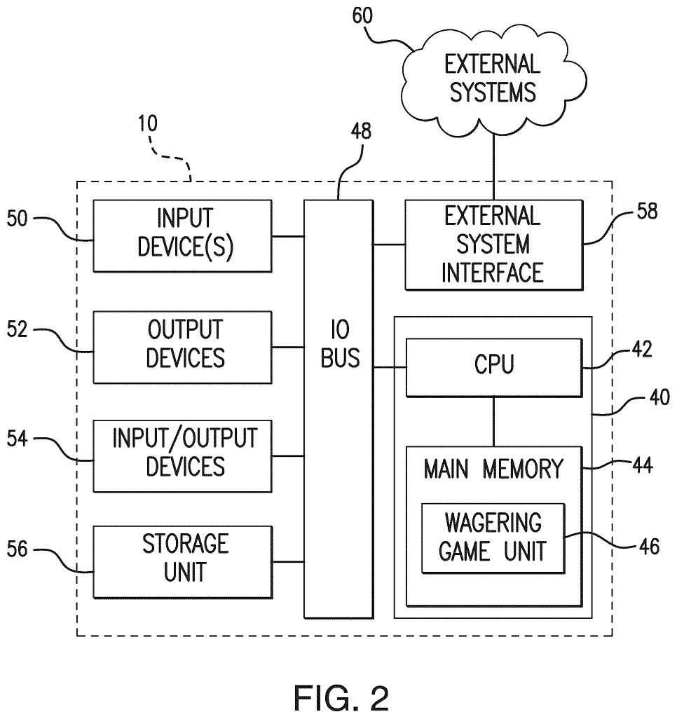

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that includes one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, includes any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, includes one or more controllers or processors and such one or more controllers or processors need not be disposed proximal to one another and may be located in different devices or in different locations. The game-logic circuitry 40, and more specifically the main memory 44, includes one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 includes a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry 40 facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method includes the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media includes storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device includes a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts includes acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

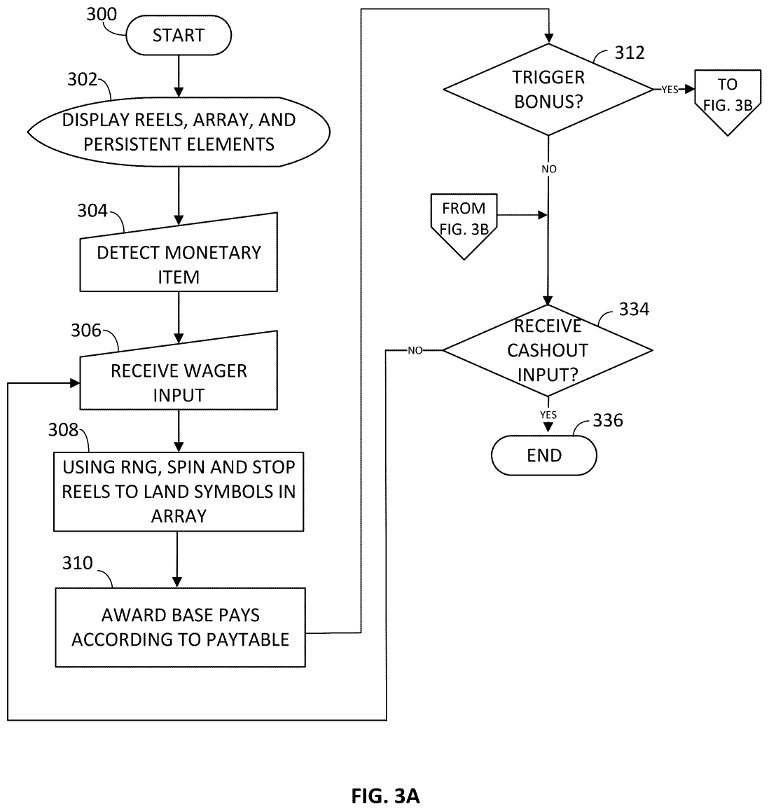

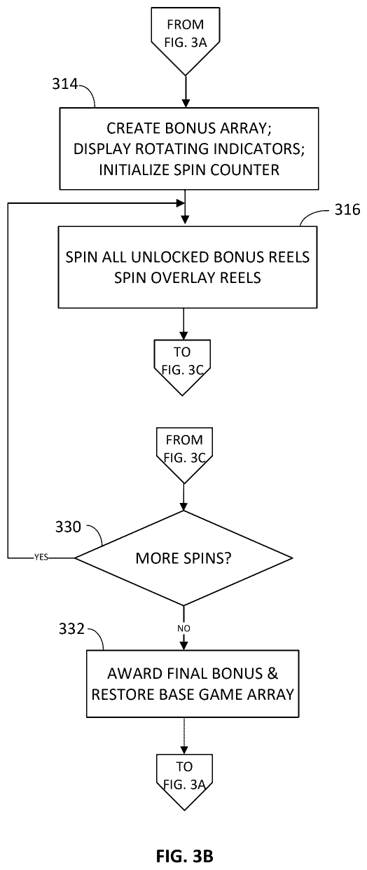

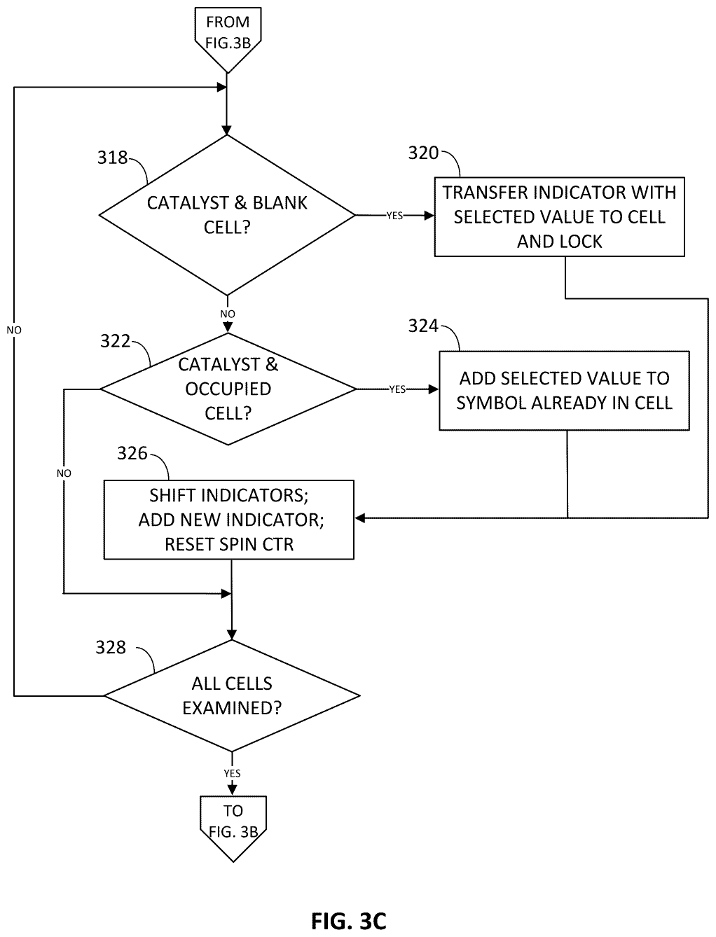

Referring now to FIGS. 3A-3C, there is shown a flow diagram representing one data processing method 300 corresponding to at least some instructions stored and executed by the game-logic circuitry 40 in FIG. 2 to perform operations according to an embodiment of the present invention. The data processing method generally describes the steps of a generic Triple Pot game. A Triple Pot game includes a base game, commonly played with a symbol array (“array”) and a number of symbol-bearing reels.

### Game Play Initiation

Referring to FIG. 3A, the data processing method commences at step 300.

At step 302, the game-logic circuitry 40 controls one or more presentation devices 18, 20 (e.g., mechanical-reel display device, video display device, or a combination thereof) of the graphical user interface to present a plurality of symbol-bearing reels and a base game array of symbol positions or “cells. ” Although the method is described with respect to one presentation device, it is to be understood that the presentation described herein may be performed by a presentation assembly including more than one presentation device.

The array may be arranged in a variety of configurations, formats, or structures and may include a plurality of rows and columns, the intersection of which form cells. The rows of the array are oriented in a generally horizontal direction, and the columns of the array are oriented in a generally vertical direction. The cells in each row of the array are horizontally aligned with each other, and the cells in each column of the array are vertically aligned with each other. Alternatively, the cells may be arranged in a honeycomb configuration with adjacent columns vertically offset from each other by one-half cell or adjacent rows horizontally offset from each other by one-half cell. The number of cells in different rows and/or different columns may vary from each other.

The reels bear a plurality of symbols that include various base game symbols and, in some embodiments, a WILD symbol that can substitute for any of the base game symbols. From play to play of the base game (a base game cycle), the reels spin and stop in response to a wager. When the reels are spun, either mechanically or in an animated fashion on a video display device, they come to a stop to “land” or “display” one or more of the symbols they bear in the cells of the symbol array. This process may be known as “populating” the symbol array. Once “landed,” a symbol may be said to be “in,” “at,” “located in,” “located at,” or to “occupy” a cell. The reels may bear a combination of symbols and blank spaces (“blanks”) such that when a given reel stops spinning, some of the cells associated with that reel need not be occupied by a symbol.

The reels may be associated with the respective columns of the array such that the reels spin vertically, and each reel populates a respective column. In another embodiment, the reels may be associated with the respective rows of the array such that the reels spin horizontally, and each reel populates a respective row. In some embodiments, the reels are associated with respective individual cells of the array such that each reel animates in place and populates only its respective cell. In some embodiments, the cells of the symbol array may be populated without spinning reels. For example, some or all of the symbols populating the array may simply be displayed in their respective cells.

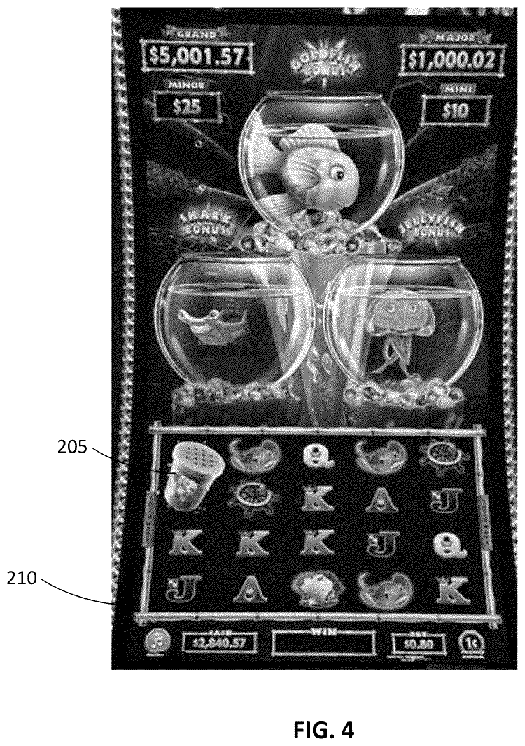

FIG. 4 illustrates an example of the display at the conclusion of a representative base-game spin. In this example, the base-game array 210 has a four-by-five rectangular configuration including twenty cells, and each cell includes a respective independent reel. The reels also bear a plurality of various visually distinct base game symbols.

At step 304, the game-logic circuitry 40 detects, via a value input device, a physical item associated with a monetary value that establishes a monetary balance in the form of cash or credits. The monetary balance may be shown on a credit meter.

### Base Game Spin

At step 306, the game-logic circuitry 40 initiates a base game cycle (i.e., spin cycle) in response to an input indicative of a wager covered by the monetary balance. To initiate a spin of the reels, the player may press a “Spin” or “Max Bet” key on a button panel or touch screen.

At step 308, using an RNG, the game-logic circuitry 40 spins and stops the reels to randomly land symbols from the reels in the array in visual association with one or more paylines (also known as lines, ways, patterns, or arrangements). The reel spin may be animated on a video display by depicting symbol-bearing strips moving vertically across the display and synchronously updating the symbols visible on each strip as the strip moves across the display. Alternatively, the reels may be physical/electromechanical reels.

### Base Game Win Evaluation

At step 310, once the reels have stopped spinning, the symbols populating the array are evaluated by the game-logic circuitry 40. Payouts are awarded in accordance with a pay table. The pay table may, for example, include “line pays,” “ways pays” and “scatter pays.” Line pays occur when a predetermined type and number of symbols appear along an activated payline, typically in a particular order such as left to right, right to left, top to bottom, bottom to top, etc. Ways pays appear on adjacent reels without the requirement to be on a specified pay line or directly adjacent to one another. Scatter pays occur when a predetermined type and number of symbols appear anywhere in the displayed array without regard to position or paylines. Each payline preferably consists of a single symbol position in each column of the array. The number of paylines may be as few as one or as many as possible given each payline consists of a single symbol position in each column of the array. To animate a standard pay, the display may apply a border, pattern, color change, background change, watermark, or other distinguishing characteristic to the winning payline and/or winning symbols that contributed to the pay.

At step 312, once basic pays have been paid according to the pay table, the game-logic circuitry 40 randomly determines, via the RNG, whether or not to trigger a bonus game. In some embodiments, the bonus game may also be triggered in response to a particular event or base game spin outcome. For example, when a catalyst symbol (represented here as a fish food shaker) 205 lands in a cell of the base game array 210, a bonus game may be triggered.

If a bonus game is not triggered at step 312, the game-logic circuitry 40 proceeds to step 334 to complete the current base game cycle. If, however, a bonus game is triggered at step 312, the game-logic circuitry 40 instead proceeds to step 314 of FIG. 3B.

### Bonus Game Initiation

At step 314, a bonus array is created to replace the base game array on the display. The bonus array may take any of the forms described above and may have the same configuration as the base game array or may have a different configuration than the base game array.

When initialized, all cells of the bonus array 230 are empty.

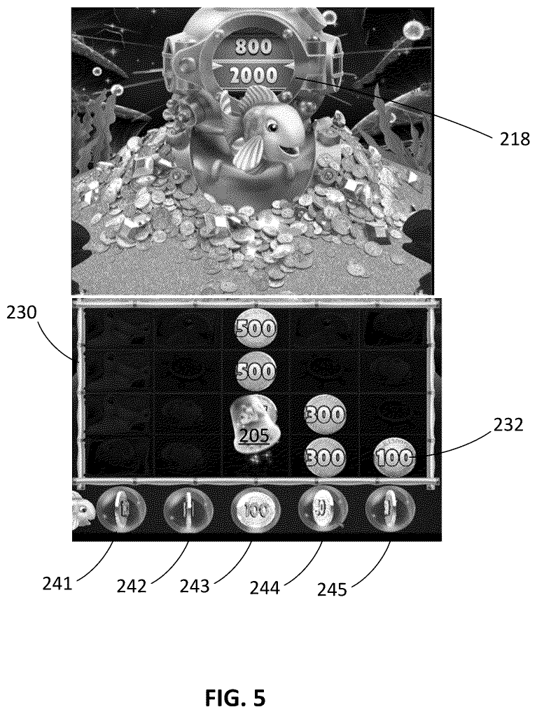

In addition, bonus reels are generated—one embodiment of which is illustrated in FIG. 4. The bonus reels bear catalyst symbols 205 and blank spaces. In the example of FIG. 5, the bonus array 230 has the same configuration as the base game array 210 and each bonus reel is associated with a cell of the bonus array 230. Thus, in the 4×5 bonus array 230, there are 20 individual bonus reels. Each bonus reel takes the form of an overlay reel bearing a mix of catalyst symbols 205 and blank spaces. An overlay reel is a reel superimposed over the cell such that any symbol previously placed in the cell is visible when the overlay reel spins. Thus, symbols on overlay reels and symbols already occupying a given cell may be co-located in the cell. The reason for this co-location will be explained further below.

At step 314, a row of rotating indicators 241-245 is displayed below the bonus array 230, one rotating indicator below each reel column. The rotation of the indicators repeatedly reveals both sides of each rotating indicator. The purpose of these rotating indicators 241-245 will also be explained below. In the example of FIG. 5, each rotating indicator 241-245 resembles a coin, though they may take any form.

Along with the bonus array 230, a spin counter is initialized and set to a predetermined value, for example, 3 spins. At step 316, the bonus reels are spun and stopped as described with respect to step 308. Flow then continues at step 318 of FIG. 3C.

### Post-Spin Phase

The game-logic circuitry iteratively evaluates each cell, checking for newly landed catalyst symbols 205, at step 318. In the event the current cell contains a newly landed catalyst symbol 205 on its bonus reel overlaying an empty cell, flow continues at step 320, otherwise flow continues at step 322.

At step 320, the rotating one or more of the indicators 241, 242, 243, 244, 245 beneath the current cell stops spinning, selecting one of its two values. The catalyst symbol 205 is removed from the bonus array 230 and the one or more of the indicators 241, 242, 243, 244, 245 below the column is then animated to move to the empty cell where, bearing the selected value, it is locked in the current cell as a value-bearing symbol 232. Such value-bearing symbols are often referred to as “What You See is What You Get” or “cash on reels” symbols. Flow then continues at step 326.

At step 322, in the event the current cell contains a newly landed catalyst symbol 205 on its bonus reel overlaying an occupied cell, flow continues at step 324, otherwise flow continues at step 328. Note: A cell may be occupied if step 320 was performed on the cell during a previous spin cycle.

At step 324, the rotating one or more of the indicators 241, 242, 243, 244, 245 beneath the current cell stops spinning, selecting one of its two values. The catalyst symbol 205 is removed from the bonus array 230 and the one or more of the indicators 241, 242, 243, 244, 245 below the column is then animated to move to the occupied cell where the value it bears is added to the value already borne by the symbol in the cell.

In some embodiments, one or more of the indicators 241, 242, 243, 244, 245 may bear a trigger symbol to play a side game to determine the value to be applied to the coin in the array. For example, when such a value is selected, a bonus wheel may be spun to select the credit value to apply to the coin. For example, as shown in FIG. 5, the bonus wheel 218 in the helmet at the top of the display would be spun to determine the credit amount to be applied. Other credit value selection methods are possible in still other embodiments.

At step 326, each time one or more of the indicators 241, 242, 243, 244, 245 below the columns has been used and removed from the plurality of indicators 241-245, the row of indicators 241-245 shifts left in a first in, first out manner. A new indicator 245 with two different values (one value per side) then appears under the rightmost column. This introduction of new values adds variety and excitement to the game as a player can hope that a high value is won before it shifts off the display and that even higher values than those shown on the display will shift into it. In other embodiments, the indicators remain fixed and do not shift off the display, may shift off the display in another direction or some, or all of the indicators (especially the one or more of the indicators 241, 242, 243, 244, 245 that has just been used) may simply be randomly replaced by new indicators 241-245 bearing different values.

Also at step 326, the spin counter is optionally reset, for example to 3 spins. At step 328, if there is another cell to be evaluated, flow returns to step 318, otherwise flow continues at step 330 of FIG. 3B.

At step 330, the game-logic circuitry 40 determines if any bonus game spins remain. The bonus game can terminate in two ways. If all positions in the bonus array 230 contain locked symbols, the bonus game ends. Otherwise, if the spin counter reaches zero, for example, if three spins in a row with no newly locked symbols occur, the bonus game also ends. In other embodiments, other game termination conditions may be applied at this step.

In the event that spins remain, flow returns to step 316 for another bonus game spin cycle, otherwise, flow continues at step 332.

At step 332, a final evaluation of the bonus array is performed and a prize is determined and awarded. The bonus array is removed and the base game array is restored.

Flow continues at step 334 of FIG. 3A, where a new base-game cycle will be initiated at step 306 if a new wager is to be made, otherwise the method ends at step 336.

FIG. 5 illustrates examples of several of the above aspects in accordance with one or more embodiments. First, six reel symbols 232 bearing various credit values are locked in the bonus array 230 from previous spins. Second, a catalyst symbol 205 has landed in the third row of the third column. In this example, the catalyst symbol 205 has been animated to tip and dispense fish food, which has floated down to the rotating indicator 243 below the third column. The rotation of the indicator 243 has stopped to select a value of 100 credits. The catalyst symbol 205 will be removed and the indicator 243 will then be animated to move to the empty cell in the bottom row of the third column and locked in place in the cell as a value-bearing symbol 232 bearing 100 credits. Third, the other rotating indicators 241, 242, 244 and 245 continue to rotate.

In this description, numerous specific details are set forth. However, it is understood that embodiments of the invention may be practiced without these specific details. Variations falling within the scope of the invention may include a spin counter that counts up rather than down. While presented as a standalone bonus game, the above principles may operate in conjunction with other bonuses or bonus enhancements during a bonus game.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

Some embodiments of the present invention include an innovative application of data processing steps that, when implemented by game-logic circuitry 40, direct a presentation assembly of the graphical user interface to present a symbol-value collection and award process that minimizes processing overhead by utilizing WYSIWYG symbols instead of complex, fanciful game images. In this way, the value-bearing symbols require fewer rules needed for the award process than would be necessary for calculating values of winning symbol combinations enumerated in stored pay tables, as found in more complex reel-spinning routines. At the same time, embodiments of the present invention provide a straightforward, WYSIWYG visual presentation that is simple to understand and, therefore, effective in generating player excitement and enthusiasm. The result is a highly flexible value-award process that can be easily adapted to any theme/brand while remaining easily understood by players.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of conducting a wagering game, the method comprising:
displaying a symbol array comprising a plurality of cells, each cell initially empty and comprising an overlay reel bearing catalyst symbols and blank spaces;
displaying a plurality of indicators, each indicator bearing a plurality of values;
initializing a spin counter;
for a plurality of game cycles:
spinning and stopping the overlay reels to display a blank space or a catalyst symbol superimposed over each cell in the symbol array;
for each respective cell in the symbol array:
determining whether the respective cell contains a catalyst symbol overlaying a symbol placed in the respective cell during a previous game cycle;
in response to the respective cell containing a catalyst symbol overlaying a symbol placed in the respective cell during a previous game cycle:
selecting one of the plurality of indicators associated with the respective cell;
selecting a value from the plurality of values borne by the selected indicator;
removing the selected indicator from the plurality of indicators and adding the selected value to a value borne by the symbol placed in the respective cell during a previous game cycle;
replacing the selected indicator in the plurality of indicators with a new indicator bearing a plurality of new values;
resetting the spin counter in response to locking a new symbol in the symbol array or adding value to a symbol already in the symbol array; and
in response to the spin counter reaching zero, ending the game and awarding a prize.

2. The method of claim 1, wherein each overlay reel is superimposed over a cell such that any symbol previously placed in the cell is visible when the overlay reel spins.

3. The method of claim 1 wherein the terminating condition comprises the spin counter reaching zero.

4. The method of claim 1 wherein the terminating condition comprises all cells in the symbol array being locked.

5. The method of claim 1 further comprising the steps of:
determining whether the respective cell contains a catalyst symbol overlaying an empty cell;
in response to the respective cell containing a catalyst symbol overlaying an empty cell:
selecting one of the plurality of indicators associated with the respective cell;
selecting a value from the plurality of values borne by the selected indicator;
removing the selected indicator from the plurality of indicators and moving the selected indicator to the respective cell, locking it in place; and
replacing the selected indicator in the plurality of indicators with a new indicator bearing a plurality of new values.

6. The method of claim 1, wherein the step of awarding a prize comprises summing the values borne by the symbols in the symbol array.

7. The method of claim 6, further comprising, after awarding the prize, removing the symbol array from a display and restoring a base game array to the display.

8. The method of claim 1, wherein the step of replacing the selected indicator in the plurality of indicators comprises shifting at least one of the remaining indicators in a predetermined direction and adding a new indicator bearing a plurality of new values to the plurality of indicators.

9. The method of claim 1, wherein the at least one of the values borne by one of the plurality of indicators comprises a trigger symbol, wherein, in response to the trigger symbol being selected, the method further comprises the step of initiating a secondary game and determining the selected value according to an outcome of the secondary game.

10. The method of claim 9, wherein the secondary game comprises a wheel game.

11. A gaming machine comprising:
a presentation assembly;
a value input device configured to accept a physical item associated with a monetary value to establish a credit balance;
a value output device configured to dispense a payout from the credit balance in response to a cashout input; and
game-logic circuitry configured to perform the operations of:
displaying a symbol array comprising a plurality of cells, each cell initially empty and comprising an overlay reel bearing catalyst symbols and blank spaces;
displaying a plurality of indicators, each indicator bearing a plurality of values;
initializing a spin counter;
for a plurality of game cycles:
spinning and stopping the overlay reels to display a blank space or a catalyst symbol superimposed over each cell in the symbol array;
for each respective cell in the symbol array:
determining whether the respective cell contains a catalyst symbol overlaying a symbol placed in the respective cell during a previous game cycle;
in response to the respective cell containing a catalyst symbol overlaying a symbol placed in the respective cell during a previous game cycle:
selecting one of the plurality of indicators associated with the respective cell;
selecting a value from the plurality of values borne by the selected indicator;
removing the selected indicator from the plurality of indicators and adding the selected value to a value borne by the symbol placed in the respective cell during a previous game cycle;
replacing the selected indicator in the plurality of indicators with a new indicator bearing a plurality of new values;
resetting the spin counter in response to locking a new symbol in the symbol array or adding value to a symbol already in the symbol array; and
in response to the spin counter reaching zero, ending the game and awarding a prize.

12. The gaming machine of claim 11, wherein each overlay reel is superimposed over a cell such that any symbol previously placed in the cell is visible when the overlay reel spins.

13. The gaming machine of claim 11 wherein the terminating condition comprises the spin counter reaching zero.

14. The gaming machine of claim 11 wherein the terminating condition comprises all cells in the symbol array being locked.

15. The gaming machine of claim 11 wherein the game-logic circuitry is further configured to perform the operations of:
determining whether the respective cell contains a catalyst symbol overlaying an empty cell;
in response to the respective cell containing a catalyst symbol overlaying an empty cell:
selecting one of the plurality of indicators associated with the respective cell;
selecting a value from the plurality of values borne by the selected indicator;
removing the selected indicator from the plurality of indicators and moving the selected indicator to the respective cell, locking it in place; and
replacing the selected indicator in the plurality of indicators with a new indicator bearing a plurality of new values.

16. The gaming machine of claim 11, wherein the step of awarding a prize comprises summing the values borne by the symbols in the symbol array.

17. The gaming machine of claim 16, wherein the game-logic circuitry is further configured to, after awarding the prize, cause the presentation assembly to remove the symbol array and restore a base game array.

18. The gaming machine of claim 11, wherein the step of replacing the selected indicator in the plurality of indicators comprises shifting at least one of the remaining indicators in a predetermined direction and adding a new indicator bearing a plurality of new values to the plurality of indicators.

19. The gaming machine of claim 11, wherein the at least one of the values borne by one of the plurality of indicators comprises a trigger symbol, wherein, in response to the trigger symbol being selected, the method further comprises the step of initiating a secondary game and determining the selected value according to an outcome of the secondary game.

20. The gaming machine of claim 19, wherein the secondary game comprises a wheel game.
